(19) United States
(12) Patent Application Publication
(10) Pub. No.: US 2009/0066579 A1
(43) Pub. Date: Mar. 12, 2009

(54) HIGH GAIN PLANAR ANTENNA

(76) Inventors: Bill LAU, Hong Kong (CN); Eddie Lau, Hong Kong (CN)

Correspondence Address: WANG & HO, 66 HILLTOP ROAD, MILLINGTON, NJ, 07946, US

(21) Appl. No.: 12/168,892

(22) Filed: Jul. 8, 2008

Related U.S. Application Data
(60) Provisional application No. 60/971,010, filed on Sep. 10, 2007.

(51) Int. Cl. H01Q 1/38

(52) U.S. Cl. 343/700 MS

(57) ABSTRACT

A planar antenna including a radiating plate, a ground plate and a support with the radiating plate being dimensioned according to the formula L>L/2>W, where L and W are the length and width of said radiating plate, respectively. The support serves to maintain the radiating plate and the ground plate at a certain distance from each other in a substantially parallel orientation. The length of the radiating plate is approximately half of the wavelength at the operating frequency of the antenna. An air layer substrate fills in the space between the radiating plate and the ground plate. The foregoing configuration help produce an antenna with small size and high gain suitable for communication devices requiring narrow bandwidth.

### CROSS REFERENCE TO RELATED APPLICATIONS

This application claims priority to U.S. Provisional Patent Application No. 60/971,010, filed Sep. 10, 2007, the contents of which are hereby incorporated by reference.

### FIELD OF THE INVENTION

This invention relates to a planar antenna used for transmitting and receiving electromagnetic signals. Particularly, it relates to a planar antenna with novel configurations of a radiating plate and a ground plate to achieve high gain, small size and easy impedance matching and band pass filtering.

### BACKGROUND OF THE INVENTION

Planar antennas are well known in the art. Referring to FIG. 5, a typical such antenna, usually with a low profile, may include a planar conductive radiating plate 127, and planar conductive ground plate or ground plate 102. The two plates 127 and 102 are in general parallel to each other. Conventionally, such planar antenna employs a probe pin 108 as the feeding meaning and the two plates are usually separated by an air-layer substrate. However, such planar antennas are not small enough for some applications, particularly as more mobile communication devices are getting smaller and smaller these days. With these planar antennas, design effort has been made for increasing the bandwidth, but there are small sized communication devices that require only a narrow bandwidth. On the other hand, micro-strip antennas are also well known in the art. They usually have smaller sizes but they typically suffer from the low efficiency (low gain) drawback. In a micro-strip antenna, the radiating plate and the ground plates are usually patched on the opposite surfaces of a dielectric substrate layer.

Therefore, there has be a need for a type of antennas with a smaller size and higher gain for being used in smaller communication devices which need a narrow band (2% bandwidth) and such need has not been filled by simple and inexpensive meanings up until this present invention.

### SUMMARY OF THE INVENTION

One objective of the present invention is to provide a simple meaning to construct a planar antenna which features both small size and high gain, and can be easily made to have different resonance frequencies and input impedances as desired.

A particular embodiment of the present invention comprises a radiating plate, a ground plate which is in a general parallel relation with the radiating plate, a support that fixes the radiating plate on the ground plate and also functions as a dielectric spacer separating the two conductive plates and provides an air player substrate therebetween.

At one end of the radiating plate, there are two feeding slots and a feeding probe. The feeding slots and feeding probe form a tank circuit. The width of the feeding slots and length of the feeding probe can be varied to provide different combinations of inductance and capacitance to give the antenna different operating frequencies and input impedances.

To reduce the antenna size, the physical dimensions of the planar antenna of the present invention is configured as:

L>L/2>W

By comparison, prior art configuration is L>W>L/2, where L and W are radiating plate's length and width, respectively, while L/2 is a half of the radiate plate's length.

In prior art design, L>W>L/2>H. H is the distance between the radiating plate and the ground plate. The dominant mode (i.e., the mode with lowest resonant frequency) is TM₀₁₀ and its next higher mode is TM₀₀₁. By comparison, for the antenna of the present invention, the size of the radiating plate would be L>L/2>W>H. The dominant mode is TM₀₁₀, and its next higher mode is T₀₂₀. Because L is a constant for an antenna with a given operating frequency, thus from this L>L/2>W>H configuration, a smaller sized antenna could be achieved.

The antenna gain test demonstrated that the planar antenna of the present invention, while with a reduced size, still performs satisfactorily in term of antenna efficacy/gain.

The various features of novelty which characterize the invention are pointed out with particularity in the claims annexed to and forming a part of this disclosure. For a better understanding of the invention, its operating advantages, and specific objects attained by its use, reference should be made to the drawings and the following description in which there are illustrated and described preferred embodiments of the invention.

### BRIEF DESCRIPTION OF DRAWINGS

FIG. 1 is a schematic prospective view of an antenna according to the present invention.

FIG. 2 is a top schematic top view of the radiating plate of the planar antenna shown in FIG. 1.

FIG. 3 depicts the antenna gain measurement setup used for determining the performance of the antenna of the present invention.

FIG. 4 shows a comparison of antenna radiation pattern between the antenna of the present invention (dotted line) and the typical monopole antenna (solid line).

FIG. 5 depicts schematically a typical prior art planar antenna using a feeding probe pin, where the width (W) of the radiating plate is greater than one half of the length of the radiating weight (L/2).

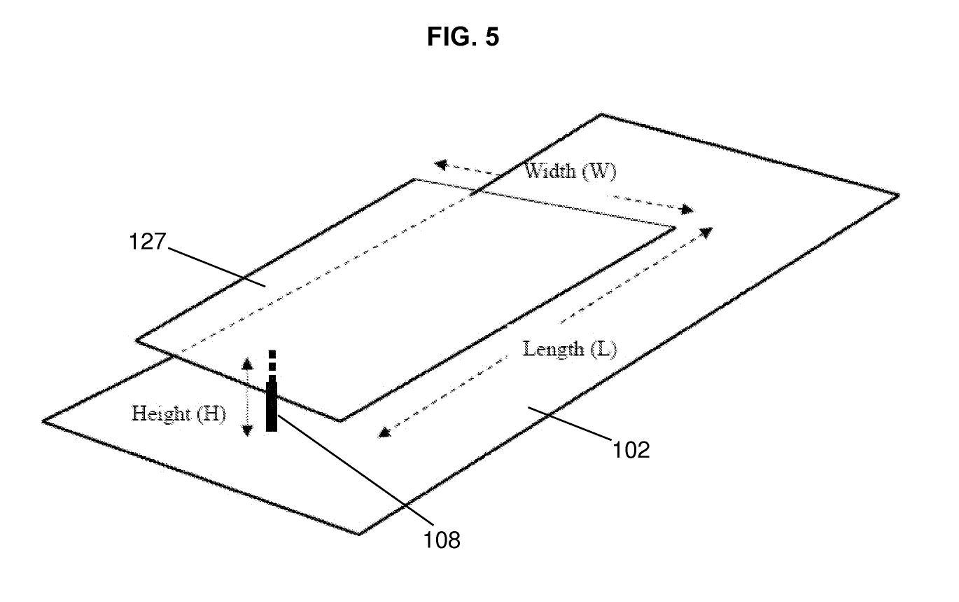

### DETAILED DESCRIPTION OF THE INVENTION WITH PARTICULAR EMBODIMENTS

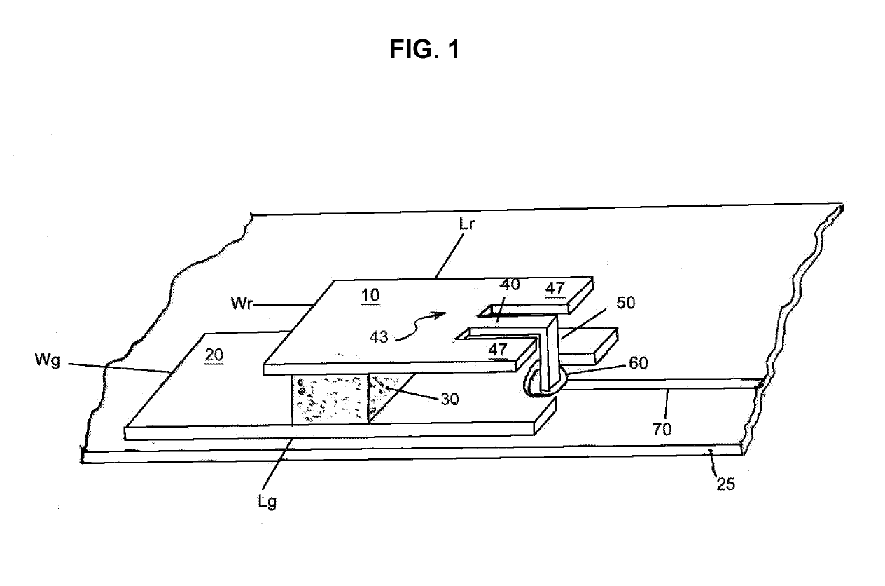

Referring to FIG. 1, it shows an exemplary planar antenna according to the present invention. The antenna includes a radiating plate 10 (also known as “radiator” or “radiated plate”) and a ground plate 20. Both the radiating plate and the ground plate are made of metal material, but other conductive materials may also provide satisfactory results. The space between the radiating plate and the ground plate is not filled with a dielectric substrate but is instead filled with an air layer. The two plates are substantially parallel with each other and are fixed on opposite sides of a dielectric support 30. The ground plate may be fixed on a dielectric substrate 25. The support serves to maintain a desired distance between the radiating plate and the ground plate and keep them substantially parallel to each other. The support can be made of any non-conducting materials, such as, for example, a cellular foam material e.g., ethylene vinyl acetate (EVA).

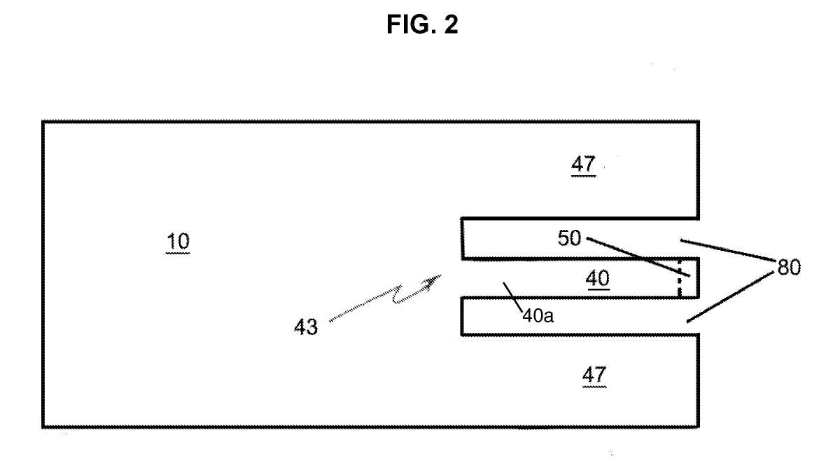

At one end of the radiating plate, there is an inner feeding location 43 and a feeding probe 40, which has a first section 40a (FIG. 2) and a second section 50. Optionally, the radiating plate may include two side portions 47 (FIGS. 1 and 2). Together, the inner feeding location, the first section of the feed probe and the side portions define two feeding slots 80 (FIG. 2). The first feeding section of the feed probe lies between the two feeding slots and lies substantially in the plane in which the radiating plate resides. It connects or extends to inner feeding location 43 of the radiating plate at one end and connects or extends to the second section at the other end. The second section of the feeding probe are preferably oriented substantially perpendicular to the first section and the radiating plate. As shown in FIG. 2, the radiating plate, the first section, and the second section may be formed from a single piece of conductive material. However, they may be formed separately and independently and then joined together. A suitable material for making the radiating plate and the feeding probe is copper plated with tin. Copper provides a highly conductive inner material while tin protects copper from oxidation. However, they may be made from other conductive materials as deemed suitable by people with ordinary skill in the art.

The second section of the feeding probe extends from the first section at one end and connects to a conductive landing pad 60 at the other end. The landing pad may be attached on the substrate on which may be printed electric circuits. The landing pad may future connect to a transmission line interface 70, which is also attached to the substrate to facilitate electric connection between the landing pad and other electronic components on the substrate.

The length of the feeding probe can be predetermined so as to provide for impedance matching (in order to accommodate a particular operating frequency) between the radiating plate and the circuitry to which the radiating plate is connected. In this manners the antenna may be tuned by varying the length of the feeding probe. Preferably, for example, the length of the first section of the feeding probe may be preset to a particular value to produce an antenna with a desired operating frequency. Alternatively, if the side portions and the feeding slots are present, the antenna may be additionally be tuned by varying the width (sw) of the slots as shown in FIG. 2.

As a particular embodiment of the present invention, the length and width of the radiating plate is 75 mm and 20 mm, respectively, and the length and width of the ground plate is 100 mm and 30 mm, respectively. The distance between the radiating plate and the ground plate is about 10 mm. The length of the radiating plate is set to be approximately one half of the wavelength at the operating frequency of the antenna.

A preferred range for the length of the radiating plate is between 70 mm and 80 mm and that for the ground plate is between 70 mm and 150 mm. The width of the radiating plate should be equal to or less than one half of its length and may range from 15 mm to 40 mm. Preferably, the width of the ground plate is slightly larger than the width of the radiating plate. Also preferably, The length of the ground plate is less than 1.5 times the length of the radiate plate and the width of the ground plate is about one half of the wavelength at the operating frequency of the antenna.

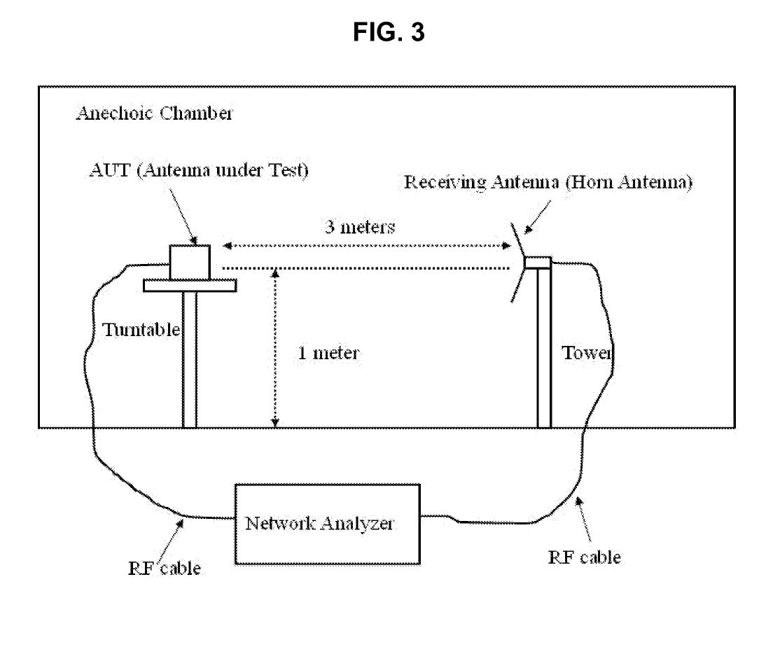

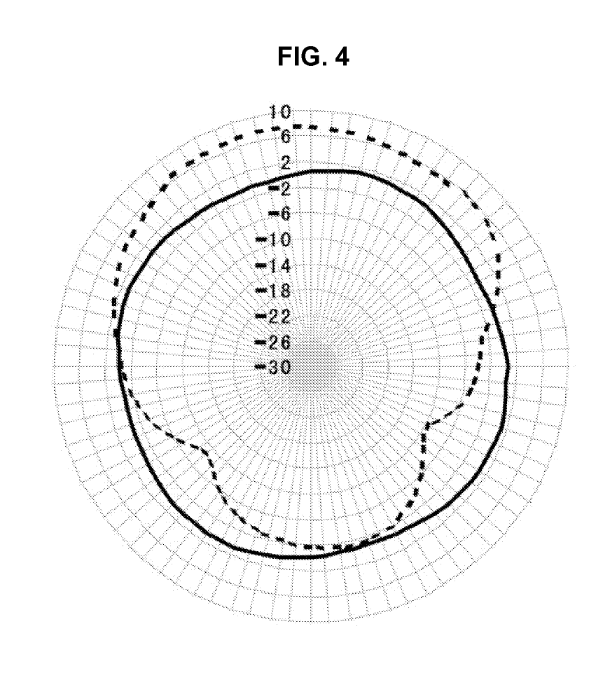

A prototype antenna of the present invention was tested on its gain/efficiency according to the measurement setup depicted in FIG. 3 and the test result is presented in FIG. 4. Referring to FIG. 3 and FIG. 4, antenna pattern is defined as a graphical representation of the radiation properties of the antenna as a function of space coordinates. The radiation pattern is determined in the far-field region according the steps as follows.

First, monopole antenna is used as the AUT (Antenna Under Test). The well-known monopole antenna exhibits omni-directional pattern with 1 dBi Antenna Gain (Solid line in FIG. 4). Its radiation pattern is recorded by measuring S21 parameters in a network analyzer versus different turn angles of AUT.

Next, the planar antenna of the present invention is used as the AUT. Its radiation pattern is recorded (Dotted line in FIG. 4). This record is compared with that of the monopole antenna to demonstrate the performance/efficiency of the planar antenna using the monopole antenna's performance as reference. The result demonstrated that the performance of the planar antenna according the present invention provides higher antenna gain at a desired direction than a monopole antenna.

While there have been described and pointed out fundamental novel features of the invention as applied to a preferred embodiment thereof, it will be understood that various omissions and substitutions and changes, in the form and details of the embodiments illustrated, may be made by those skilled in the art without departing from the spirit of the invention. The invention is not limited by the embodiments described above which are presented as examples only but can be modified in various ways within the scope of protection defined by the appended patent claims.

What is claimed is:

1. A planar antenna, comprising a feeding probe, a radiating plate, a ground plate and a support, said support maintaining said radiating plate and said ground plate at a predetermined distance from each other and said radiating plate being dimensioned as follows:
L>L/2>W>H, where L and W are the length and width of said radiating plate, respectively and H is the distance between said radiating plate and said ground plate.

2. The planar antenna according to claim 1, wherein there is an air substrate layer between said radiating plate and ground plate.

3. The planar antenna according to claim 2, wherein L is approximately half of the wavelength at the antenna's operating frequency.

4. The planer antenna according to claim 3, wherein said feeding probe comprises a first section and a second section, said second section being substantially perpendicular to said first section.

5. The planer antenna according to claim 4, wherein said second section of said feeding probe is in electric connection to a conductive pad.

6. The planer antenna according to claim 5, wherein said conductive pad is in electric connection to a transmission line interface, which is attached to a substrate to facilitate electric connection between said landing pad and other electronic components on said substrate.

7. The planer antenna according to claim 1, wherein the length of said radiating plate is between 70 mm and 80 mm and the length of said ground plate is between 70 mm and 150 mm.

8. The planer antenna according to claim 7, wherein the length of said radiating plate is between 70 nm and the width of said radiating plate is 34.9 mm.

9. The planer antenna according to claim 8, wherein the width of said radiating plate is between 15 mm to 40 mm.

10. The planer antenna according to claim 9, wherein the width of said ground plate is larger than the width of said radiating plate.

11. The planer antenna according to claim 10, wherein the distance between said radiating plate and said ground plate is about 10 mm.

12. The planer antenna according to claim 1, wherein the length of said ground plate is less than 1.5 times the length of said radiate plate and the width of said ground plate is about one half of the wavelength at an operating frequency of said antenna.
